(19) United States
(12) Patent Application Publication
(10) Pub. No.: US 2010/0005294 A1
(43) Pub. Date: Jan. 7, 2010

(54) Security in Wireless Environments Using Out-Of-Band Channel Communication

(76) Inventors: Kari Kostiainen, Helsinki (FI); Jan-Erik Ekberg, Vantaa (FI); Nitesh Saxena, Grenoble (FR)

Correspondence Address: Hollingsworth & Funk, 8500 Normandale Lake Blvd., Suite 320, Minneapolis, MN, 55437, US

(21) Appl. No.: 12/083,708

(22) PCT Filed: Oct. 18, 2005
(86) PCT No.: PCT/IB2005/003107

§ 371 Date: Sep. 22, 2009

(51) Int. Cl. H04L 9/32

(52) U.S. Cl. 713/168

(57) ABSTRACT

A methodology of using an (preferably uni-directional) out-of-band channel for secure information transmission between two devices capable for LPRF communication is provided. Information, which is intended for secure transmission from one of the devices to the other device, is encoded into a time dependent visual sequence. The visual sequence may comprise one or more visual signals, in particular lighted-up and dark states. The visual sequence is emitted in a time-dependent visual signal by a light emitter of the one device and the emitted signal is detected by a light sensor of the other device on the basis of the detected signal. The time-dependent signal especially timely varies in the light intensity. The light sensor generates a (time-dependent) sequence of detection signals. These detection signals are decoded to reconstruct the information intended for secure transmission. The out-of-band channel transmission of the information being separate from the LPRF communication enables to transmit a shared secret. The shared secret is required for secure authentication of the devices during initialization of the LPRF communication.

The present invention relates to wireless data communication. In particular, the present invention relates to security aspects in wireless data communication environments using out-of-band channel communication.

Low-power radio frequency communications are becoming increasingly popular especially in the field of portable consumer electronic (CE) devices comprising for instance personal digital assistants (PDAs), electronic organizers, cellular (telephone) terminals, so-called smart phones/communicators, notebooks, personal computers, digital cameras, etc for primarily connecting to peripheral or accessory devices comprising for instance printers, head sets, network access points, GPS (Global Position System) receivers, etc. Originally the development of low-power radio frequency communication technologies or proximity radio technologies was primarily driven on the one side by the desire for substituting bothering wired connections to peripheral or accessory devices and on the other side for flexibility in network interconnection. In accordance with those two basic approaches, the development in low-power radio frequency communication technologies has resulted in two technology standards known as Bluetooth and WLAN (wireless local area network), which are widely accepted and implemented in a huge number of portable and stationary CE devices. These two radio frequency communication technologies are standardized under the authority of the Bluetooth Special Interest Group (SIG) and the Institute of Electrical and Electronics Engineers (IEEE), respectively. Of course, the development in the field of low-power radio frequency communication technology is increasingly continued in particular in view of data rates, power consumption, interference sensitivity, range of coverage, etc. Today, the launch of promising future low-power radio frequency communication technologies such as UWB (Ultra-Wide Band) is imminent.

Beneath the original purpose of the low-power radio frequency communication technology for connecting to peripheral or accessory devices and/or for connecting to networks, the wide-spread use of (portable) devices capable for low-power radio frequency communications promotes the desire for ad-hoc networking, i.e. to establish an ad-hoc network among devices of several users. In the near future, this kind of networking will become much more usual. Each device capable for networking will become a network node taking advantage of services offered by other devices capable for networking. Such ad-hoc networks have been for instance developed on the basis of Bluetooth technology known as Piconets. Bluetooth technology protocols allow one master device to interconnect with up to seven active slave devices. Many other slave devices can be inactive, or parked, and the master device can bring parked devices back into active status at any time.

Due to the nature of radio frequency data communication technology and especially in the field of ad-hoc networking, security aspects have to be considered. In principle, communications over radio frequency interconnections can be easily tapped within the range of coverage of the radio frequency signals. Moreover, especially referring to ad-hoc networks, it should be of special interest to ensure that the communication counterpart is trustworthy. These security aspects, which are imminent for any radio frequency communication technology, can be summarized under the terms authenticity, confidentiality, integrity, and availability.

Conventionally, authenticity and confidentiality is ensured on the basis of a common secret about which two devices capable for LPRF (low-power radio frequency) communication are informed at an initialization procedure. With reference to the Bluetooth standard, this initialization procedure is known as device pairing procedure. Before the actual pairing procedure starts, the two Bluetooth enabled devices (one being the master device and the other one being the slave device) participating in the initialization procedure have to be informed about the common secret, which is a PIN (Personal Identification Number), which is a 1-16 bytes long sequence (8-128 bit sequence). On the basis of this PIN, a 128 bit random number generated typically by the master device and one of the 48 bit BD_ADDRs (Bluetooth Device Addresses) of the master device and slave device an initialization key Kᵢₙᵢₜ is created using the E₂₂ algorithm. By the means of the initialization key Kᵢₙᵢₜ the Bluetooth enabled devices exchange two new created 128 bit random sequences LK_RAND_{A} and LA_RAND_{B}, one of which created by the master device and the slave device, respectively. Now, each of the both Bluetooth enabled devices knows the two random sequences LK_RAND_{A} and LA_RAND_{B} and create the link key K_{ab} using the E₂₁ algorithm. The link key K_{ab} once created is conventionally used for any future mutual authentication between the now paired Bluetooth enabled devices and for optionally creating encryption keys to secure the data communication therebetween.

The method of entering the PIN is regarded as the weakest point in achieving security of the Bluetooth connection. Typically, users tend to use simple and short PINs (usually 4 digits) that are not secure enough to prevent an attacker to crack the PIN. Moreover, peripheral/accessory devices enabled for Bluetooth communication are available without any user interface and/or input means for entering a PIN; for instance the highly popular Bluetooth headsets. Such devices have pre-installed PIN and moreover the PIN should be fixed and cannot be changed by the user. Still worse, the pre-installed PIN is just trivial and equal for a huge number of identical devices, for instance “0000”. Furthermore, it should be mentioned that the typical user tends to maintain a pre-installed PIN even if it is recommended to replace the pre-installed PIN with an individual PIN.

In addition when referring to the aforementioned ad-hoc networks, the user of the master device, to which the slave devices connect, has to enter a number of N−1 PINs for initializing the communication connections to each other slave device, where N is the number of the total devices in the ad-hoc network. This circumstance can be very bothering for the user of the master device.

Note that analog or similar initialization procedures are used for joining of a WLAN enabled device in a WLAN.

The basic object to be overcome by the present invention is to provide an improved methodology applicable in a wireless data communication, which requires initialization on the basis of a shared secret between two wireless devices. The inventive methodology is efficient and user-acceptable.

In particular, one object of the present invention is to establish a secure methodology for sharing the common secret between the two wireless devices and another object of the present invention is to ensure usability. In view of the security, a protocol for sharing the common secret should be designed to guarantee protection against a potential man-in-the-middle attack that tries to impersonate as a trusted communication counterpart. In view of the usability, the users of the wireless devices should be involved in the initialization at a minimum.

The objects of the present invention are solved by features of the accompanying claims.

According to an aspect of the present invention, a method, and a system, is provided, for using an out-of-band channel for secure information transmission between two devices capable for LPRF communication. Preferably, the out-of-band channel may be a uni-directional out-of-band channel and operable in a visual frequency band. Information, which is intended for secure transmission from one of the devices to the other device, is encoded into a time dependent visual sequence. The visual sequence may comprise one or more visual signals, in particular lighted-up and dark states. The visual sequence is emitted in a time-dependent signal by a light emitter of the one device and the visual sequence is detected by a light sensor of the other device on the basis of the detected signal. The time-dependent signal especially timely varies in the light intensity. The light sensor generates a (time-dependent) sequence of detection signals. These detection signals, i.e. the sequence of detection signals, are decoded to reconstruct the information intended for secure transmission. The out-of-band channel transmission of the information being separate from the LPRF communication enables to transmit a shared secret. The shared secret is required for secure authentication of the devices during initialization of the LPRF communication.

According to another aspect of the present invention, a device of using an out-of-band channel for secure information transmission is provided. The device is capable for LPRF communication with a counterpart device. Information intended for secure transmission is encoded into a visual sequence, which is emitted in a time-dependent signal by a light emitter of the device. The visual sequence is provided for detection by a light sensor of the counterpart device. A sequence of detection signals is obtainable from the light sensor in the counterpart device. The sequence of detection signals is decodable to reconstruct the information intended for secure transmission. The out-of-band channel transmission of the information separate from the LPRF communication enables to transmit a shared secret, which is required for secure authentication of the devices during initialization of the LPRF communication.

According to another aspect of the present invention, a device of using an out-of-band channel for secure information receipt is provided. The device is capable for LPRF communication with a counterpart device. Information intended for secure transmission is preferably encoded into a visual sequence by the counterpart device and the visual sequence is emitted in a time-dependent signal by a light emitter of the counterpart devices. Then, a light sensor of the device detects the visual sequence. A sequence of detection signals is obtained from the light sensor on the basis of the detected signal/visual sequence. The sequence of detection signals is decoded to reconstruct the information intended for secure transmission. The out-of-band channel transmission of the information separate from the LPRF communication enables to transmit a shared secret, which is required for secure authentication of the devices during initialization of the LPRF communication.

According to an embodiment of the present invention, the light emitter is a light emitting diode. The light sensor is a light diode, an ambient light sensor, or an image capturing module (a digital camera).

According to an embodiment of the present invention, the information is encoded bitwise and each bit value of the information is converted in a predefined visual symbol. The at least two visual symbols, one of which representing the bits 0 and the other one representing the bit 1, comprises in turn one or more visual signals.

According to an embodiment of the present invention, each bit value is converted into one or more lighted-up and dark states of the light emitter. The lighted-up state and dark state of the light emitter represent corresponding visual signals, respectively. The lighted-up and/or the dark states are persistent for one or more pre-defined periods of time. One or more transitions between the states, which are persistent for one or more pre-defined periods of time, form a visual symbol.

According to an embodiment of the present invention, frequency modulation is used for encoding the information into the visual sequence.

According to an embodiment of the present invention, the sampling frequency of the light sensor exceeds the minimum sampling frequency required for correctly detecting the visual sequence emitted in the time-dependent signal.

According to an embodiment of the present invention, the light sensor is an image capturing module, which captures a sequence of images during emission of the visual sequence. Each captured image is integrated to obtain a detection value. Integration may be an integration in space, an integration over an area, and/or an integration in time. Preferably, the integration is performed numerically. Then, a current detection value is compared to one or more previous detection values such that based on the determined difference the information is decoded and reconstructed from the captured images.

According to an embodiment of the present invention, the captured images are converted into monochrome images.

According to an embodiment of the present invention, each captured image is analyzed to identify an image area including the emitted time-depended signal of the light emitter. The resulting area is integrated to obtain a detection value from each captured image. The remaining image outside of the resulting area is neglected.

For a better understanding of the present invention and to understand how the same may be brought into effect reference will now be made, by way of illustration only, to the accompanying drawings, in which:

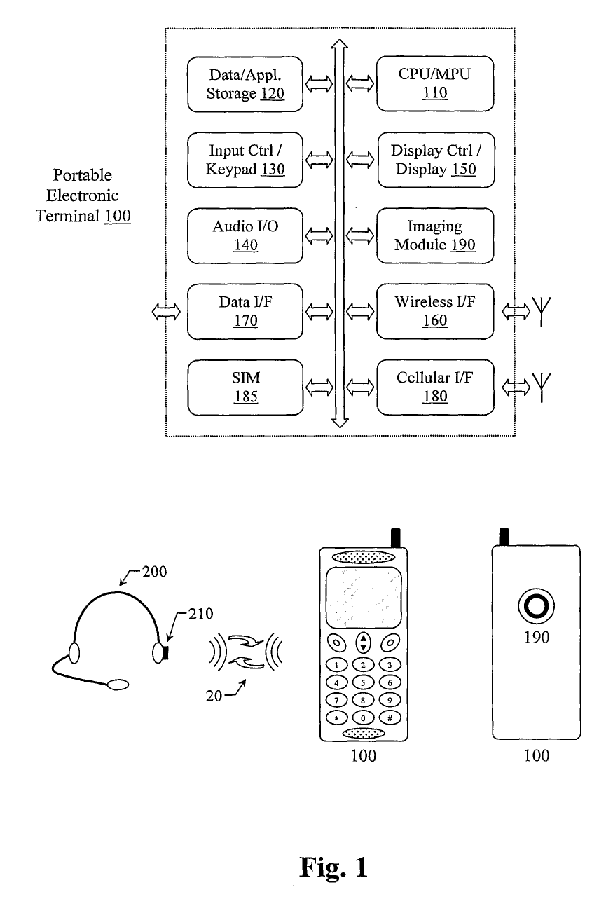

FIG. 1 illustrates a schematic block diagram of components of a processing terminal embodied on the basis of a portable electronic terminal according to an embodiment of the present invention;

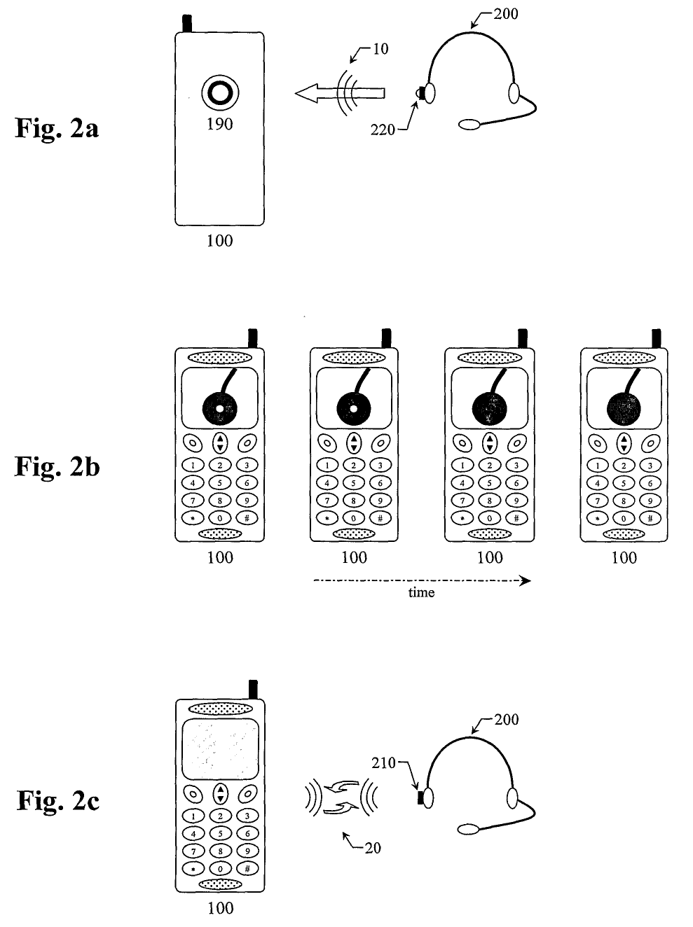

FIG. 2a illustrates a schematic block diagram of a system during uni-direction out-of-band channel transmission according to an embodiment of the present invention;

FIG. 2b illustrates a schematic illustration of a capturing result according to an embodiment of the present invention; and

FIG. 2c illustrates a schematic block diagram of a system according to an embodiment of the present invention.

Throughout the description below, same and/or equal components will be referred by the same reference numerals.

Reference will be given to the initialization and pairing procedure in accordance with the Bluetooth standard. However, it should be noted that the present invention is not limited to Bluetooth technology and/or any specific Bluetooth standard. Similar or analog initialization and pairing procedures are commonly used in the field of wireless communication technology including especially WLAN and UWB. Those skilled in the art will appreciate on the basis of the following description that the inventive concept is applicable with any wireless communication technology which requires the sharing of a common secret between at least two devices enabled for wireless communication for initializing the data communication therebetween.

FIG. 1 shows a schematic block illustration of components of a portable electronic terminal 100 in an exemplar form of a mobile/cellular telephone terminal. The portable electronic terminal 100 exemplarily represents any kind of processing terminal or device employable with the present invention. It should be understood that the present invention is neither limited to the illustrated portable electronic terminal 100 nor to any other specific kind of processing terminal or device.

As aforementioned, the illustrated portable electronic terminal 100 is exemplarily carried out as cellular communication enabled portable user terminal. In particular, the portable electronic terminal 100 is embodied as a processor-based or micro-controller based system comprising a central processing unit (CPU) and a mobile processing unit (MPU) 110, respectively, a data and application storage 120, cellular communication means including cellular radio frequency interface (I/F) 180 with radio frequency antenna (outlined) and subscriber identification module (SIM) 185, user interface input/output means including typically audio input/output (I/O) means 140 (conventionally a microphone and a loudspeaker), keys, keypad and/or keyboard with key input controller (Ctrl) 130 and a display with display controller (Ctrl) 150, a (local) wireless data interface (I/F) 160, and a general data interface (I/F) 170.

The operation of the portable electronic terminal 100 is controlled by the central processing unit (CPU)/mobile processing unit (MPU) 110 typically on the basis of an operating system or basic controlling application, which controls the functions, features and functionality of the portable electronic terminal 100 by offering their usage to the user thereof. The display and display controller (Ctrl) 150 are typically controlled by the processing unit (CPU/MPU) 110 and provide information for the user including especially a (graphical) user interface (UI) allowing the user to make use of the functions, features and functionality of the portable electronic terminal 100. The keypad and keypad controller (Ctrl) 130 are provided to enable the user inputting information. The information input via the keypad is conventionally supplied by the keypad controller (Ctrl) to the processing unit (CPU/MPU) 110, which may be instructed and/or controlled in accordance with the input information. The audio input/output (I/O) means 140 includes at least a speaker for reproducing an audio signal and a microphone for recording an audio signal. The processing unit (CPU/MPU) 110 can control conversion of audio data to audio output signals and the conversion of audio input signals into audio data, where for instance the audio data have a suitable format for transmission and storing. The audio signal conversion of digital audio to audio signals and vice versa is conventionally supported by digital-to-analog and analog-to-digital circuitry e.g. implemented on the basis of a digital signal processor (DSP, not shown).

The keypad operable by the user for input comprises for instance alphanumeric keys and telephony specific keys such as known from ITU-T keypads, one or more soft keys having context specific input functionalities, a scroll-key (up/down and/or right/left and/or any combination thereof for moving a cursor in the display or browsing through the user interface (UI), a four-way button, an eight-way button, a joystick or/and a like controller.

The portable electronic terminal 100 according to a specific embodiment illustrated in FIG. 1 includes the cellular interface (I/F) 180 coupled to the radio frequency antenna (outlined) and operable with the subscriber identification module (SIM) 185. The cellular interface (I/F) 180 is arranged as a cellular transceiver to receive signals from the cellular antenna, decodes the signals, demodulates them and also reduces them to the base band frequency. The cellular interface (I/F) 180 provides for an over-the-air interface, which serves in conjunction with the subscriber identification module (SIM) 185 for cellular communications with a corresponding base station (BS) of a radio access network (RAN) of a public land mobile network (PLMN). The output of the cellular interface (I/F) 180 thus consists of a stream of data that may require further processing by the processing unit (CPU/MPU) 110. The cellular interface (I/F) 180 arranged as a cellular transceiver is also adapted to receive data from the processing unit (CPU/MPU) 110, which is to be transmitted via the over-the-air interface to the base station (BS) of the radio access network (RAN). Therefore, the cellular interface (I/F) 180 encodes, modulates and up-converts the data embodying signals to the radio frequency, which is to be used for over-the-air transmissions. The antenna (outlined) of the portable electronic terminal 100 then transmits the resulting radio frequency signals to the corresponding base station (BS) of the radio access network (RAN) of the public land mobile network (PLMN). The cellular interface (I/F) 180 preferably supports a 2^{nd} generation digital cellular network such as GSM (Global System for Mobile Communications) which may be enabled for GPRS (General Packet Radio Service) and/or EDGE (Enhanced Data for GSM Evolution), a 3^{rd} generation digital cellular network such as UMTS (Universal Mobile Telecommunications System), and/or any similar or related standards for cellular telephony.

The wireless data interface (I/F) 160 is depicted exemplarily and should be understood as representing one or more wireless network interfaces, which may be provided in addition to or as an alternative of the above described cellular interface (I/F) 180 implemented in the exemplary portable electronic terminal 100. A large number of wireless network communication standards are available today. For instance, the portable electronic terminal 100 may include one or more wireless network interfaces operating in accordance with any IEEE 802.xx standard, Wi-Fi standard, any Bluetooth standard (1.0, 1.1, 1.2, 2.0+EDR, LE), ZigBee (for wireless personal area networks (WPANs)), Infra-Red Data Access (IRDA), Wireless USB (Universal Serial Bus), RFID (radio frequency identification) communication, especially NFC (Near Field Communication) and/or any other currently available standards and/or any future wireless data communication standards such as UWB (Ultra-Wideband).

Moreover, the general data interface (I/F) 170 is depicted exemplarily and should be understood as representing one or more data interfaces including in particular network interfaces implemented in the exemplary portable electronic terminal 100. Such a network interface may support wire-based networks such as Ethernet LAN (Local Area Network), PSTN (Public Switched Telephone Network), DSL (Digital Subscriber Line), and/or other current available and future standards. The general data interface (I/F) 170 may also represent any data interface including any proprietary serial/parallel interface, a universal serial bus (USB) interface, a Firewire interface (according to any IEEE 1394/1394a/1394b etc. standard), a memory bus interface including ATAPI (Advanced Technology Attachment Packet Interface) conform bus, a MMC (MultiMediaCard) interface, a SD (SecureData) card interface, Flash card interface and the like.

The portable electronic terminal 100 according to an embodiment of the present invention comprises an image capturing module 190 which is applicable for taking still images and/or video sequences. Such imaging modules 190 also designated digital camera or camera module are typically implemented or detachably connectable to a large number of portable consumer electronic (CE) devices including especially cellular telephone terminals, personal digital assistants (PDAs), electronic organizer/communicators, notebooks, and the like. In accordance with the desire of the market, portable CE devices develop to more or less multimedia multi-purpose terminals. Conventionally, one or more imaging and/or video applications are provided to be run on the portable electronic terminal 100. The imaging and/or video applications enable to store, handle, and/or manipulate still images and/or video sequences captured by the means of the image capturing module 190. For instance, the electronic device 100 may optionally comprise a hardware and/or software implemented video encoder module (not shown), which is capable for encoding/compressing video input signals to obtain compressed digital video sequences (and e.g. also digital pictures) in accordance with one or more video codecs and especially operable with an image capturing module 190 providing video input signals, and a video decoder module 210 enabled for encoding compressed digital video sequences (and e.g. also digital pictures) in accordance with one or more video codecs.

The image capturing module 190 is preferably a sensor for capturing one or more images. Typically such an image capturing module 190 consisting of an integrated circuit (IC) containing an array of linked, or coupled, capacitors. Under the control of an external circuit, each capacitor can transfer its electric charge to one or other of its neighbors. Such integrated circuit containing an array of linked, or coupled, capacitors is well known by those skilled in the art as charge-coupled device (CCD). Other image capturing technologies may be also used.

The components and modules illustrated in FIG. 1 may be integrated in the portable electronic terminal 100 as separate, individual modules, or in any combination thereof. Preferably, one or more components and modules of the portable electronic terminal 100 may be integrated with the processing unit (CPU/MPU) forming a system on a chip (SoC). Such system on a chip (SoC) integrates preferably all components of a computer system into a single chip. A SoC may contain digital, analog, mixed-signal, and also often radio-frequency functions. A typical application is in the area of embedded systems and portable systems, which are constricted especially to size and power consumption constraints. Such a typical SoC consists of a number of integrated circuits that perform different tasks. These may include one or more components comprising microprocessor (CPU/MPU), memory (RAM: random access memory, ROM: read-only memory), one or more UARTs (universal asynchronous receiver-transmitter), one or more serial/parallel/network ports, DMA (direct memory access) controller chips, GPU (graphic processing unit), DSP (digital signal processor) etc. The recent improvements in semiconductor technology have allowed VLSI (Very-Large-Scale Integration) integrated circuits to grow in complexity, making it possible to integrate all components of a system in a single chip.

Typical applications operable with the portable electronic terminal 100 comprise beneath the basic applications enabling the data and/or voice communication functionality a contact managing application, a calendar application, a multimedia player application, a WEB/WAP browsing application, and/or a messaging application supporting for instance Short Message Services (SMS), Multimedia Message Services (MMS), and/or email services. Modern portable electronic terminals are programmable; i.e. such terminals implement programming interfaces and execution layers, which enable any user or programmer to create and install applications operable with the portable electronic terminal 100. A today's well established device-independent programming language is JAVA, which is available in a specific version adapted to the functionalities and requirements of mobile device designate as JAVA Micro Edition (ME). For enabling execution of application programs created on the basis of JAVA ME the portable electronic terminal 100 implements a JAVA MIDP (Mobile Information Device Profile), which defines an interface between a JAVA ME application program, also known as a JAVA MIDlet, and the portable electronic terminal 100. The JAVA MIDP (Mobile Information Device Profile) provides an execution environment with a virtual JAVA engine arranged to execute the JAVA MiDlets. However, it should be understood that the present invention is not limited to JAVA ME programming language and JAVA MIDlets; other programming languages especially proprietary programming languages are applicable with the present invention.

In order to illustrate the basic concept of the present invention which overcomes the problems and disadvantages of conventional authentication approaches used in LPRF communication today, a short introduction will be given to the Bluetooth standard and the authentication procedure used. The authentication procedure is performed between two Bluetooth enabled devices, which intend to communicate with each other. The authentication procedure is operated to ensure that a communication link is established between these two Bluetooth enabled devices.

A LPRF communication link 20 between two Bluetooth enabled devices is exemplary outlined in FIG. 1. Herein, a headset 200 is depicted for the sake of illustration, which implements a Bluetooth transceiver/interface (I/F) 210 adapted to communication with a corresponding Bluetooth transceiver of the portable electronic device 100 via the communication link 20. With reference to the Bluetooth standard, different Bluetooth communication profiles are defined. The profiles consider the different requirements and device functions of specific Bluetooth enabled peripheral/accessory devices and/or Bluetooth enabled counterpart devices.

It should be noted that the Bluetooth enabled headset 200 represents any LPRF communication enabled counterpart device communicating with the portable electronic terminal 100 capable for LPRF communication.

In the following, the initialization procedure of the Bluetooth standard will be briefly described for the sake of illustration. It should be noted that the Bluetooth standard and initialization procedure are out of the scope of the present invention, respectively. Details thereof can be found in the respective standard description.

One main part of the initialization procedure is the authentication procedure, which is based on a challenge-response scheme.

One of the Bluetooth enabled devices will be designated in the following as verifier whereas the other one will be designated as claimant.

Authentication uses a challenge-response scheme in which a claimant's knowledge of a secret key is checked through a 2-move protocol using symmetric secret keys. The latter implies that a correct claimant/verifier pair shares the same secret key, for example K. In the challenge-response scheme the verifier challenges the claimant to authenticate a random input (the challenge), denoted by AU_RAND_{A}, with an authentication code, denoted by E₁, and return the result SRES to the verifier. The input to E₁ consists of the tuple including AU_RAND_{A} and the Bluetooth device address (BD_ADDR) of the claimant. This means, the verifier sends a random number (the challenge) to the claimant, which calculates a response that is a function of this challenge, the claimant's Bluetooth Address (BD_ADDR), and a secret key. This response is sent back to the verifier, which checks whether the received response matches with an expected response or not. A successful calculation of the authentication response requires that the two Bluetooth enabled devices, i.e. the verifier and the claimant, share a common secret key. The use of this address prevents a simple reflection attack. The secret K shared by Bluetooth enabled devices A and B is a current link key K_{AB}.

The verifier is not required to be the master. The application indicates which device has to be authenticated. Some applications only require a one-way authentication. However, some peer-to-peer communications should use a mutual authentication, in which each device is subsequently the challenger (verifier) in two authentication procedures. The Link Manager (LM) being part of the Bluetooth implementation processes authentication preferences from the application to determine in which direction(s) the authentication(s) takes place. For mutual authentication with the Bluetooth enabled devices, after Bluetooth enabled device A has successfully authenticated Bluetooth enabled device B, Bluetooth enabled device B authenticates Bluetooth enabled device A by sending an AU_RAND_{B} (different from the AU_RAND_{A} that Bluetooth enabled device A issued) to Bluetooth enabled device A, and deriving the SRES and SRES′ from the new AU_RAND_{B}, the address of Bluetooth enabled device A, and the link key K_{AB}.

This secret link key K is created during the pairing procedure of two Bluetooth enabled devices.

The secret key K used for authentication is derived through a procedure E₁ having two modes denoted E₁₁ and E₂₁, respectively. In the first mode, E₁₁ produces a 128-bit kink key, using a 128-bit RAND value and a 48-bit address (BD_ADDR). This mode is utilized when creating unit keys and combination keys. In the second mode, E₂₁ produces a 128-bit link key, using a 128-bit RAND value and an octet user PIN (Personal Identification Number). The second mode is used to create the initialization key, and also when a master key is to be generated.

When the initialization key Kᵢₙᵢₜ is generated, the PIN is augmented with the 48-bit address (BD_ADDR). The augmentation always starts with the least significant octet of the address immediately following the most significant octet of the PIN. Since the maximum length of the PIN used in the algorithm cannot exceed 16 octets, it is possible that not all octets of BD_ADDR will be used.

An initialization key Kᵢₙᵢₜ is used temporarily during initialization. This initialization key Kᵢₙᵢₜ is derived by an algorithm E₂₂ from a BD_ADDR, a PIN code, the length of the PIN (in octets), and a random number IN_RAND. The 128-bit output from E₂₂ is used for key exchange during the generation of a link key. When the Bluetooth enabled devices have performed the link key exchange, the initialization key Kᵢₙᵢₜ will be discarded.

When the initialization key Kᵢₙᵢₜ is generated, the PIN is augmented with the BD_ADDR. If one device has a fixed PIN the BD_ADDR of the other device shall be used. If both devices have a variable PIN the BD_ADDR of the device that received IN_RAND shall be used. If both devices have a fixed PIN they cannot be paired. Since the maximum length of the PIN used in the algorithm cannot exceed 16 octets, it is possible that not all octets of BD_ADDR will be used. This procedure ensures that the initialization key Kᵢₙᵢₜ depends on the identity of the device with a variable PIN. A fraudulent device may try to test a large number of PINs by claiming another BD_ADDR each time. It is the application's responsibility to take countermeasures against this threat. If the device address is kept fixed, the waiting interval before the next try may be increased exponentially.

To use a combination key and especially a link key K_{AB}/K_{BA}, it is first generated during the initialization procedure. The combination key is the combination of two numbers generated in Bluetooth enabled device A and B, respectively. First, each device shall generate a random number, LK_RAND_{A} and LK_RAND_{B}. Then, utilizing with the random number and their own BD_ADDRs, the two random numbers

LK_{—}KA=E₂₁(LK_RAND_{A},BD_ADDR_{A}), EQ 1;

and

LK_{—}KB=E₂₁(LK_RAND_{B},BD_ADDR_{B}), EQ 2.

are created in Bluetooth enabled device A and device B, respectively. These numbers constitute the devices' contribution to the combination key that is to be created. Then, the two random numbers LK_RAND_{A} and LK_RAND_{B} shall be exchanged securely by XORing with the current link key, K. Thus, device A shall send K ⊕ LK_RAND_{A} to device B, while device B shall send K ⊕ LK_RAND_{B} to device A. If this is done during the initialization phase the link key K=Kᵢₙᵢₜ.

When the random numbers LK_RAND_{A} and LK_RAND_{B} have been mutually exchanged, each device recalculates the other device's contribution to the combination key. This is possible since each device knows the Bluetooth device address of the other device. Thus, Bluetooth enabled device A calculates EQ 2 and Bluetooth enabled device B calculates EQ 1. After this, both Bluetooth enabled devices combine the two numbers to generate the 128-bit link key. The combining operation is a simple bitwise modulo-2 addition (i.e. XOR). The result shall be stored in device A as the link key K_{AB} and in device B as the link key K_{BA}. When both devices have derived the new combination key, a mutual authentication procedure is initiated to confirm the success of the transaction. An old link key will be discarded after a successful exchange of a new combination key.

From the above introduction to Bluetooth initialization procedure, those skilled in the art will appreciate that the PIN, which represent the initial shared secret, is of crucial interest. Although, the description refers to the Bluetooth standard, other LPRF communication standards implement similar, analog, or equal initialization procedures to handle the authentication of devices participating in the LPRF communication. An initial shared secret, which has to be shared between at least two LPRF communication enabled devices, is the basis of the authentication. The initial shared secret may be a PIN, a pass phrase, or any other secret numeric, character and/or alphanumeric sequence. Hence, the aforementioned Bluetooth initialization procedure can be considered as a representative authentication concept of a large number of initialization procedures used in different LPRF communication technologies and standards.

The methodology of user-entered initial secrets is regarded as the weakest point in achieving security. Typically, users tend to use simple and short initial secrets that are not secure enough to prevent an attacker to crack the secret. Moreover, peripheral/accessory devices enabled for LPRF communication are available without any user interface and/or input means for user input. Such devices have pre-installed secrets, which may additionally be fixed and cannot be changed even if the user wishes. Or still worse, the pre-installed secret is just trivial and equal for a huge number of identical devices. Furthermore, it should be mentioned that the typical user tends to maintain a pre-installed PIN even if it is recommended to define a user specific one at first putting into operation to replace the pre-installed secret.

In order to deal with the aforementioned problems and disadvantages, the present invention is conceptually based on a new method for initializing security in wireless environments, especially in wireless ad hoc environments. In this inventive method the shared secret, which may be a PIN, a pass phrase, any alphanumeric sequence, a hash value of a public key, or whatever information is needed for initializing security in the particular application at hand, is encoded into a visual sequence, shown on one LPRF communication enabled device, recorded with the other LPRF communication device, and finally decoded on the other LPRF communication device.

By the term visual sequence a time varying optical signal should be understood including especially a sequence of LED blinks, a sequence of different or varying images or two-dimensional bar codes. This means that the secret information is coded as a visual sequence, which is transmitted in a channel completely separated from the LPRF communication channel used for communication between the devices. Those skilled in the art will appreciate on the basis of the following description that the channel utilized for transmitting the visual sequence is an out-of-band channel separated from the LPRF communication channel actually used for communication between the participating devices. The inventive concept falls back on components which are typically implemented in such LPRF communication enabled devices and is especially applicable with display-limited and display-less devices.

With reference to FIGS. 2a to 2c, the inventive concept according to an embodiment of the invention will be described on the basis of the portable electronic terminal 100 and the headset 200, which are described above with reference to FIG. 1. It should be assumed that an authenticated LPRF communication, especially Bluetooth communication, should be established between the portable electronic terminal 100 and the headset 200. For sharing the common secret (e.g. the PIN) enabling the authentication, the aforementioned concept of a visual sequence via an out-of-band channel is utilized.

The chosen encoding/decoding scheme and the type of the visual sequence depend on the characteristics of the transmitting and receiving modules provided by the headset 200 and the portable electronic terminal 100, respectively. Several alternatives exist, including in particular:
A The transmitting module is a light emitter such as an emitting diode (LED) or a display or keypad illumination light emitter, or a small (a few pixels and/or low resolution) display and the receiving module is a light sensitive sensor, e.g. an ambient light sensor or a light diode;
B The transmitting module is one or several light emitter (e.g. LEDs), for instance arranged in an array, one or several display or keypad illumination light emitters, or a small (a few pixels and/or low resolution) display and the receiving module is an image capturing module, for instance a digital camera; and
C The transmitting module is a more complex (large number of pixels and/or high resolution) display and the receiving module is an image capturing module, e.g. a digital camera.

In common to all alternatives, the transmitting module is capable to at least produce a sequence in time of visual signals. In accordance with the transmitting modules of the alternatives according to embodiments of the present invention, the time sequence in time of the visual signals include a sequence in time of (one-dimensional) light/dark contrasts produced by a light emitting diode or a display, a sequence in time of two-dimensional images, where at least subsequent images produced by a display differ, or any other sequence in time of visual signals. The receiving module is adapted to detect the visual signals and is further arranged to resolve the sequence in time of the visual signals. This means, the receiving module generates at least the same number of detection values as the number of visual signals comprised by the sequence in time. In accordance with the sampling theorem, the sampling frequency of the receiving module has to be at least two times the frequency of the sequence in time of the visual signals.

With reference to the alternative A, the implementation of a light emitter (e.g. a LED, a display or keypad illumination light emitter, or a small display) as well as a corresponding light sensitive sensor (e.g. a light diode, an ambient light sensor) is economically favorable. Typical terminal devices such as the aforementioned terminal 100 comprises light emitter, typically one or more light emitting diodes, to illuminate keys, keypads, keyboards and/or the keys thereof to enable user inputs therewith in gloomy or dark environments. Today's displays technology uses, beneath light back scattering mechanisms, back lights to illuminate displayed content on the display to enable visual impression of the displayed content in (sunny, day-) light, gloomy and/or dark environment. Moreover, even embedded devices, peripheral devices, accessory devices and the like can be provided with a light emitter or the devices have already implemented one or more light emitters (LEDs) for instance to indicate operational states (power on/off) or battery/accumulator capacity. Such light emitters are sufficient for generating a visual sequence of visual symbols, which in turn comprises one or more visual signals according to an embodiment of the present invention. The implementation of a control logic, which is adapted to encode an information or data into corresponding driving signals of the light emitters and to control the operation of the one or more light emitters in accordance with the driving signals, is obtainable with relative small effort.

Furthermore, small display, i.e. display having only few pixels and/or a low resolution can be also utilized as a light emitter. Such display can be switched lighted up to emit light and can be switched dark such that the display does not emit any light. The display can be completely switched or the display can be partly switched. In the latter case, the display may be partitioned into one or more sections to simulate one or more separate light emitters.

The same applies to the implementation of a light sensitive sensor. Even embedded devices, peripheral devices, accessory devices, and the like can be provided with a light sensitive sensor. Moreover, a large number of portable devices with displays implement ambient light sensors for adjusting the brightness of the displays. Such an ambient light sensor may be used according to an embodiment of the present invention. The implementation of a detection logic, which is adapted to detect the visual sequence, to decode the original information or data embedded in the visual sequence and to reconstruct the original information or data from the detected signals, is also obtainable with relative small effort.

With reference to the alternatives B, image capturing modules are already implemented in or detachably connected to a large number of portable electronic terminals such as the terminal 100 described above in detail. Such image capturing modules are typically embodied as digital cameras which are at least capable to capture series of still images at a given frequency. Improved digital cameras are capable to take video sequences at a given frame rate. Basically, the video sequences are composed of a sequence of still images at the frame rate. Those skilled in the art will appreciate, that such an image capturing module can be used as a light sensitive sensor. The implementation of a detection logic operable with the image capturing module can be done on the basis of a software application, which is adapted to analyze each image of the captured sequence of images or video frames in order to detect the visual sequence within the images/frames and to decode and reconstruct the original information or data from the detected signals of the images/frames.

If the transmitting device has a really small display, or only few LEDs, the information can be encoded into very simple bar codes, e.g. a device with four LEDs can show a sequence of bar codes containing four bits of information per frame (including the error correction bits). In the most limited case, the transmitting device has only a single LED or the receiving device has a very primitive sensor instead of a proper camera. In this case the information can be encoded into a sequence of blinks of a single LED.

Due to the fact that a feedback channel is not available, all synchronization information should be included in the transmitted signal, as well as necessary preambles and postambles. The synchronization information, the preambles, and/or the postambles might be pre-defined; i.e. the pre-defined synchronization information, the preambles, and/or the postambles are known on transmitting as well as receiving side. According to an embodiment of the present invention, an exemplary coding for the alternative B is presented, where the transmitting device is a single LED:

0(period of time)=LED (or light emitter, generally) off; and

1(period of time)=LED (or light emitter, generally) on.

The LED on emits light with a pre-defined characteristic which should be designated as a first visual signal, whereas the LED off does not emit any light, which should be designated as a second visual signal. On the basis of these two visual signals, one or more visual symbols can be formed.

A bit encoding may have following form:
Bit 1: 0(HZ) 1(HZ) 0(HZ) 1(HZ); and
Bit 0: 0(2*HZ) 1(2*HZ),
   where HZ designates a (pre-defined) period of time. This means, the visual symbol representing the bit “1” comprises four visual signals each having a pre-defined duration in time, whereas the visual symbol representing the bit “0” comprises two visual signals each having a pre-defined duration in time different from the duration of the visual signals used for representing the bit “1”. The period of time depends preferably on the capability of the employed light emitter and on the expected detecting (frame) rate of the light sensitive sensor, i.e. the ambient light sensor, the light diode or the image capturing sensor (digital camera), for instance. The sampling theorem should be considered. Those skilled in the art will appreciate that the aforementioned example represents an exemplary frequency modulation encoding of a bit sequence.

The visual encoded bit sequence should preferably include one or more preambles, postambles, and/or (simple) checksums. A preamble may be used to indicate the start of transmission of a visual sequence encoding a bit sequence, whereas a postamble may be used to indicate the end of the transmission of the visual sequence encoding the bit sequence. The preamble may be a (pre-defined) synchronization signal which enables the receiving device to determine information enabling the decoding including for instance the basic signal frequency used for encoding the visual sequence.

The transmitting module should additionally send the visual encoded bit sequence repeatedly one or several times. The repetition of the sequence should improve the detectability whether the visual sequence has been completely detected and/or the detection was successful, i.e. free of any errors.

It should be understood that the aforementioned encoding into a visual sequence is applicable to any bit sequence representing any data and/or information. Moreover, the aforementioned encoding on the basis of visual symbols according to an embodiment of the invention should not limit the present invention. Alternative visual symbols could be defined. Furthermore, the decoding of the visual sequence encoded on the basis of the visual symbol definition described above is obtainable by a receiving algorithm, which is preferably informed about the visual symbols employed, the basic visual signal frequency, and/or the start/end of the visual sequence encoding the bit sequence.

The checksum may be any hash value obtained by any hash algorithm (such as Message Digest Hash Algorithm (e.g. MD-2 to MD-5), Secure Hash Algorithm (e.g. SHA-0 to SHA-256), Cyclic Redundancy Check (CRC); the present invention should not be understood as limited thereto) computed from the data/information to be visual encoded. For the sake of simplicity, the checksum may be appended to the data/information to be visual encoded and the obtained composed bit sequence is then visual encoded to a visual sequence for being transmitted over the out-of-band (OOB) channel. Further composition techniques may be employed for combining the bit sequence and the checksum.

The receiving algorithm on the side of the receiving module being an image capturing module 190 can be implemented as follows:
For each image/frame, the pixels received from the image capturing module are treated as monochrome;
For each image/frame, the pixel values over the entire image/frame are added together to obtain a single detection value from the image/frame; and
For each image/frame, the current detection value is compared to one or more previous detection values (i.e. from images/frames captured previous in time) and based on the difference(s) it can be deduced whether there is a signal transition from “0” (lighted up) to “1” (dark) or vice versa.

The detection of a signal transition can be improved by comparing differences in successive detection values against a floating average thereof, for instance a floating average of the 10-15 last detection values. In this case, variations in background lighting can be effectively eliminated. Once the signal transitions are determined, the bit sequence may be reconstructed on the basis of the visual symbol definition.

Those skilled in the art will appreciate that the algorithm described above can be transferred into an algorithm applicable with a light sensitive sensor, which supplies light intensity values in response to the incident light intensity. In this case, the captured intensity values of the light sensitive sensor represent directly integral light intensity. This means, the current detection value, herein the light intensity value, is compared to one or more previous detection values (i.e. the light intensity values captured previously in time by the light sensitive sensor) and based on the difference(s) it can be deduced whether there is a signal transition from “0” to “1” or vice versa. In order to improve the sensibility of the light sensitive sensor, the frequency characteristics thereof should be adapted to the emission characteristics of the light emitter employed.

For more complex recognition algorithms according to an embodiment of the invention, the basic algorithm itself breaks down into several parts:
For each image/frame, finding an area within the each captured image/frame that contains the visual signal generated by the light emitter;
For each image/frame, compensating against movements of the image capturing module (the digital camera), background fluctuations, etc;
Reading out the information from each captured image/frame in accordance with the corresponding determined areas comprising the visual signal; and
Applying error correction for instance on the basis of a checksum included.

Additionally, the capturing at a sample rate extending the minimum sample rate is advantageously. The capturing of two or more images/frames for each single visual signal of the sequence enables reducing the error probability of the visual signal detecting, especially when the visual signal covers only a small area of the entire image/frame, one or more images/frames are blurred, one or more images/frames are out-of-focus, etc. The two or more images/frames for each single visual signal can be combined (using for instance one or more image enhancing algorithms) to obtain a quality improved image/frame to be analyzed or read out. It should be noted that digital cameras of cellular telephone terminals such as terminal 100 operate typically at a frame rate of 10-20 Hz. In future, improved frame rates can be expected.

Moreover, it should be noted that the inventive concept according to an embodiment of the invention is based on a uni-directional (out-of-band channel) communication in the visual frequency band. The communication is preferably operated in an asynchronous manner. Consequently, the captured light intensity values detected by the means of the light sensitive sensor, or the pixel values obtained from the captured images/frames, are not necessarily synchronous with the timely sequence of the visual signals. This means, the intensity values, or image/frames, may be captured at a moment in time where the light emitter is actually switched from lighted up to dark or vice versa.

Referring back to the exemplary frequency modulation encoding of the visual sequence to encode a bit sequence, those skilled in the art will appreciate that the determination of how long the light emitter is lighted up is not exact. The receiving module as proposed herein is a cumulative light intensity sensor (both the light sensitive sensor as well as the image capturing module); i.e. cumulative in the period of time over which the detection value is actually sampled/captured. In this case, capturing at a sample rate extending the minimum sample rate is applicable to detect reliable detection values determined from more than one captured value per visual signal. In particular, the sample rate should be selected to enable detecting each signal transition. Once the detection of each signal transition is enabled and periods of time between the signal transitions are obtained, the reconstructing of the bit sequence in accordance with the visual symbol definition is operable.

In a further embodiment according to the present invention, colored light emitters may be used on transmitting side. On receiving side, color sensitive light sensitive sensors or a color image capturing module is required for capturing decodable detection values. Light diodes having correspondingly adapted frequency characteristics can be employed or color filters can be used. Today's image capturing modules such as digital cameras are color sensitive. The filtering of the colors can be obtained by performing digital color filtering during evaluation of the captured images/frames. Correspondingly, the number of visual signals is improved and consequently, the visual symbol definition may take advantage of the increased number of visual signals applicable for transmission. Note that two colors allow up to four visual signals, three colors allow up to six visual signals and n colors allow up to 2*n visual signals.

With reference to alternative C, a complex display, i.e. a display with a large number of pixels and/or a high resolution can also be operated as light emitter. The display can be switched lighted up and dark. Note that the description given with respect to alternative B having a small display also applies to this alternative C with a complex display. However, a complex display as transmitting module can be likewise used to display a sequence in time of visual structures, which can be captured by the image capturing module as the receiving module. In particular bar codes, i.e. one-dimensional or two-dimensional bar codes, can be employed as visual structures to be displayed. Whereas, the maximum amount of information of a bar code is approximately 70 bits, the displaying of a sequence in time of visual bar codes enables to encode any amount of information. Those skilled in the art will appreciate that the aforementioned algorithms can be adapted straightforward to the recognition and decoding of a sequence of bar codes.

Due to the fact that it is possible to capture multiple images/frames of each bar code of a sequence of bar codes and the location of bar codes can be detected using these frames, the user effort in manually locating the display displaying the sequence of bar codes is minimized. Blurred and/or out-of-focus images can be compensated using image enhancement algorithms.

In another embodiment, transmission of the visual sequence is repeated until pairing has succeeded, until the process is stopped by the user, or until a time-out occurs. In this way, additional tolerances against faulty operation can be achieved. One example of such faulty operation could be that the user does not position the light emitting device (light emitter) in time in a position relative to the detecting device that allows reliable detection.

In this embodiment, a (visual) start and a stop symbol have been defined in order to mark the start and the end of the transmitted visual sequence. The start and/or a stop symbol may comprise a predefined visual start signal and/or a predefined visual stop signal. Such a start/stop signal may be designated by a specific pre-defined period of time the signal is driven. The start and/or a stop symbol may comprise one or more sequence of predefined visual signals or visual signal transitions, which indicate the start and the end, respectively. Moreover, the start and/or a stop symbol may comprise any other visual start and stop symbol definition, respectively. The start and/or a stop symbol are preferably known to the transmitting module as well as the receiving module.

One advantage of the present invention is the fact that this scheme can be applied to devices with only very limited out-of-band channel capabilities such as a device with only one LED. An example use case would be Bluetooth pairing between a cellular telephone terminal such as terminal 100 and a Bluetooth headset such as headset 200. Typically, headsets do not have any displays. Instead, most of existing headsets already have a LED 220 (or one could be added to headsets with very little extra cost). This way, the headset can encode the hash value of its public key as a sequence of LED flashes and emits 10 the sequences of LED flashes to the cellular telephone terminal 100, which records this with its digital camera such as illustrated in FIGS. 2a and 2b. Note that FIG. 2b illustrates the visual sequence coding the bit value 1 according to an embodiment of the present invention. The images illustrated in FIG. 2b are captured at half of the minimum sampling rate. After detection of the visual sequence and decoding the hash value thereof, an authenticated initialization 20 of the Bluetooth interfaces (I/F) of the terminal 100 (wireless interface (I/F) 160) and the headset 200 (Bluetooth transceiver 210) is operable. The secure transmission of the hash value ensures that the authentication is reliable.

Another advantage of the inventive scheme according to an embodiment of the present invention is the fact that the amount of information/data that can be transmitted by the means of the visual sequence is not limited. In some applications (e.g., where a permanent public key is used for authentication) there would be the desire to transmit a full-length hash of 160 bits. The present invention enables to transmit full-length hashes of public keys as a single visual sequence.

The concept of the present invention offers better usability compared with known approaches, as the user does not have to manually focus and adjust its device to locate the screen on other device and thus the effort is minimized during the protocol.

In addition to security initialization, there are also additional use cases for encoding information into sequences of visual signals. To name one, a device could encode its friendly name or MAC address as a visual sequence and broadcast it to other devices. The other devices could then connect this device over the primary channel using the received name or address. This would be certainly easier for the user than entering the address of the device manually or selecting the friendly name from a long list of (similar or meaningless) names.

Even though the invention is described above with reference to embodiments according to the accompanying drawings, it is clear that the invention is not restricted thereto, but it can be modified in several ways within the scope of the invention defined by the claims appended.

1. Method of using an out-of-band channel for secure information transmission between two apparatuses capable for low power radio frequency communication, wherein information intended for secure transmission is encoded into a visual sequence, which visual sequence is emitted in a time-dependent signal by a light emitter of one of the apparatuses, and the visual sequence is detected by a light sensor of the other apparatus, wherein a sequence of detection signals is obtained from the light sensor, which sequence is decoded to reconstruct the information intended for secure transmission, wherein the out-of-band channel transmission of the information separate from the low power radio frequency communication enables to transmit a shared secret, which is required for secure authentication of the apparatuses during initialization of the low power radio frequency communication wherein the light sensor is an image capturing module which captures a sequence of images during emission of the visual sequence, wherein each captured image is integrated to obtain a detection value and a current detection value is compared to one or more previous detection values such that based on the determined difference the information is decoded from the captured images.

2. The method of claim 1, wherein the light emitter is a light emitting diode.

3. The method of claim 1, wherein the information is bit encoded and each bit value is converted in a predefined visual symbol.

4. The method of claim 3, wherein the each bit value is converted into one or more lighted-up and dark states of the light emitter, wherein the lighted-up and/or the dark states are persistent for one or more pre-defined periods of time and form a visual symbol.

5. The method of claim 1, wherein frequency modulation is used for encoding the information in the visual sequence.

6. The method of claim 1, wherein the sampling frequency of the light sensor exceeds the minimum sampling frequency required for correctly detecting the visual sequence emitted in the time-dependent signal.

7. (canceled)

8. The method of claim 1, wherein the captured images are converted into monochrome images.

9. The method of claim 1, wherein each captured image is analyzed to identify an image area including the emitted time-depended signal of the light emitter, wherein the area is integrated to obtain a detection value from each captured image.

10. System of using an out-of-band channel for secure information transmission, wherein the system comprises two apparatuses capable for low power radio frequency communication, wherein information intended for secure transmission is encoded into a visual sequence, which visual sequence is emitted in a time-dependent signal by a light emitter of one of the apparatuses, and the visual sequence is detected by a light sensor of the other apparatus, wherein a sequence of detection signals is obtained from the light sensor, which sequence is decoded to reconstruct the information intended for secure transmission, wherein the out-of-band channel transmission of the information separate from the low power radio frequency communication enables to transmit a shared secret, which is required for secure authentication of the apparatuses during initialization of the low power radio frequency communication wherein the light sensor is an image capturing module, which captures a sequence of images during emission of the visual sequence wherein each captured image is integrated to obtain a detection value and a current detection value is compared to one or more previous detection values such that based on the determined difference the information is decoded from the captured images.

11. The apparatus of claim 19, wherein the light emitter is a light emitting diode.

12. The apparatus of claim 19, wherein the information is bit encoded and each bit value is converted in a predefined visual symbol.

13. The apparatus of claim 12, wherein the each bit value is converted into one or more lighted-up and dark states of the light emitter, wherein the lighted-up and/or the dark states are persistent for one or more pre-defined periods of time and form a visual symbol.

14. The apparatus of claim 19, wherein frequency modulation is used for encoding the information in the visual sequence.

15. The apparatus of claim 20, wherein the sampling frequency of the light sensor exceeds the minimum sampling frequency required for correctly detecting the visual sequence emitted in the time-dependent signal.

16. (canceled)

17. The apparatus of claim 20, wherein the captured images are converted into monochrome images.

18. The apparatus of claim 20, wherein each captured image is analyzed to identify an image area including the emitted time-depended signal of the light emitter, wherein the area is integrated to obtain a detection value from each captured image.

19. Apparatus for using an out-of-band channel for secure information transmission, wherein the apparatus is capable for low power radio frequency communication with a counterpart apparatus, wherein information intended for secure transmission is encoded into a visual sequence, which visual sequence is emitted in a time-dependent signal by a light emitter of the apparatus, and the visual sequence is provided for detection by a light sensor of the counterpart apparatus, wherein the out-of-band channel transmission of the information separate from the low power radio frequency communication enables to transmit a shared secret, which is required for secure authentication of the apparatuses during initialization of the low power radio frequency communication wherein the light sensor is an image capturing module, which captures a sequence of images during emission of the visual sequence, wherein each captured image is integrated to obtain a detection value and a current detection value is compared to one or more previous detection values such that based on the determined difference the information is decoded from the captured images.

20. Apparatus for using an out-of-band channel for secure information receipt, wherein the apparatus is capable for low power radio frequency communication with a counterpart apparatus, wherein information intended for secure transmission is encoded into a visual sequence, which visual sequence is detected by a light sensor of the apparatus, wherein a sequence of detection signals is obtained from the light sensor on the basis of the detected signal, which sequence is decoded to reconstruct the information intended for secure transmission, wherein the out-of-band channel transmission of the information separate from the low power radio frequency communication enables to transmit a shared secret, which is required for secure authentication of the apparatuses during initialization of the low power radio frequency communication wherein the light sensor is an image capturing module, which captures a sequence of images during emission of the visual sequence, wherein each captured image is integrated to obtain a detection value and a current detection value is compared to one or more previous detection values such that based on the determined difference the information is decoded from the captured images.

21-22. (canceled)

23. The apparatus of claim 20, wherein the information is bit encoded and each bit value is converted in a predefined visual symbol.

24. The apparatus of claim 23, wherein the each bit value is converted into one or more lighted-up and dark states of the light emitter, wherein the lighted-up and/or the dark states are persistent for one or more pre-defined periods of time and form a visual symbol.

25. The apparatus of claim 20, wherein the information in the visual sequence is encoded by frequency modulation.

26. Apparatus for using an out-of-band channel for secure information transmission between two apparatuses capable for low power radio frequency communication, the apparatus comprising:
encoding means for encoding information intended for secure transmission into a visual sequence;
light emitting means for emitting said visual sequence in a time-dependent signal by said light emitting means of one of the apparatuses;
light sensing means for detecting the visual sequence by the other apparatus;
decoding means for decoding a sequence of detection signals obtained from the light sensor to reconstruct the information intended for secure transmission;
wherein the out-of-band channel transmission of the information separate from the low power radio frequency communication enables to transmit a shared secret, which is required for secure authentication of the apparatuses during initialization of the low power radio frequency communication;
wherein the light sensing means is an image capturing means, for capturing a sequence of images during emission of the visual sequence;
further comprising,
integrating means for integrating each captured image is integrated to obtain a detection value; and
comparing means for comparing a current detection value to one or more previous detection values such that based on the determined difference the information is decoded from the captured images.

27. Method of using an out-of-band channel for secure information transmission between two apparatuses capable for low power radio frequency communication, said method comprising at one of said apparatuses:
encoding information intended for secure transmission into a visual sequence;
emitting said visual sequence in a time dependent signal by a light emitter of said one apparatus;
wherein the visual sequence is configured for detection by a light sensor of the other apparatus, for obtaining a sequence of detection signals from the light sensor, for decoding the sequence to reconstruct the information intended for secure transmission;
wherein the out-of-band channel transmission of the information separate from the low power radio frequency communication enables to transmit a shared secret, which is required for secure authentication of the apparatuses during initialization of the low power radio frequency communication; and
wherein the visual sequence is configured for detection by a light sensor being an image capturing module, which captures a sequence of images during emission of the visual sequence, wherein each captured image is integrated to obtain a detection value and a current detection value is compared to one or more previous detection values such that based on the determined difference the information is decoded from the captured images.

28. The method of claim 27, wherein the light emitter comprises a light emitting diode.

29. The method of claim 27, further comprising at said one apparatus
bit encoding of said information; and
converting each bit value in a predefined visual symbol.

30. The method of claim 29, further comprising at said one apparatus
converting the each bit value into one or more lighted-up and dark states of the light emitter, wherein the lighted-up and/or the dark states are persistent for one or more pre-defined periods of time and form a visual symbol.

31. The method of claim 27, further comprising at said one apparatus
encoding the information in the visual sequence by using frequency modulation.

32. Method of using an out-of-band channel for secure information transmission between two apparatuses capable for low power radio frequency communication, the method comprising:
detecting by a light sensor of one apparatus a visual sequence, said visual sequence comprising therein encoded information intended for secure transmission, and wherein said visual sequence, have been emitted in a time-dependent signal by a light emitter of the other one of the apparatuses;
obtaining at the one apparatus sequence of detection signals from the light sensor;
decoding at said one apparatus said sequence to reconstruct the information intended for secure transmission;
wherein the out-of-band channel transmission of the information separate from the low power radio frequency communication enables to transmit a shared secret, which is required for secure authentication of the apparatuses during initialization of the low power radio frequency communication;
wherein the light sensor of the one device is an image capturing module;
wherein said method further comprises
capturing a sequence of images of the visual sequence;
integrating each captured image to obtain a detection value; and
comparing a current detection with one or more previous detection values such that based on the determined difference the information is decoded from the captured images.

33. The method of claim 32, wherein the information is encoded in the visual sequence by using frequency modulation.

34. The method of claim 32, wherein the sampling frequency of the light sensor exceeds the minimum sampling frequency required for correctly detecting the visual sequence emitted in the time-dependent signal.

35. The method of claim 32, further comprising converting said captured images into monochrome images.

36. The method of claim 32, further comprising:
analyzing each captured image is analyzed to identify an image area including the emitted time-depended signal of the light emitter, and
integrating said area to obtain a detection value from each captured image.
